(19) United States
(12) Patent Application Publication
(10) Pub. No.: US 2012/0160147 A1
(43) Pub. Date: Jun. 28, 2012

(54) Boat hull cleaning system

(76) Inventors: Anthony L. Newt, Windsor, CO (US); Jo Ann Newt, Windsor, CO (US)

(21) Appl. No.: 12/930,103

(22) Filed: Dec. 27, 2010

(51) Int. Cl. B63B 59/06; B23P 11/00

(52) U.S. Cl. 114/222; 29/428

(57) ABSTRACT

A device for cleaning a boat hull which provides a flexible line having central portion along which a plurality cleaning elements have spaced engagement with each of the plurality of cleaning elements having body from which a plurality of flexible members extend outwardly and thorough which the flexible line centrally passes and methods of using such device for cleaning a boat hull.

### FIELD OF THE INVENTION

A device for cleaning a boat hull which provides a flexible line having central portion along which a plurality cleaning elements have spaced engagement with each of the plurality of cleaning elements having a body from which a plurality of flexible members extend and through which the flexible line centrally passes and methods of using such device for cleaning a boat hull of a boat.

### BACKGROUND OF THE INVENTION

Maintaining a clean boat hull can improve the performance and prolong the life of a boat while avoiding more expensive maintenance procedures. Conventional methods for cleaning a boat hull are typically by mechanical or chemical means out of water. To remove a boat from the water requires a lift and transport from the location at which the boat is docked to a boat yard at which the boat hull can be cleaned. Alternately, the boat can be supported above low tide and cleaned between low and high tide. Chemical means may include toxins or poisons which can necessitate the use of special equipment such as over garments and respirators and require extensive clean up after use.

Certain devices and methods for cleaning a boat hull while submerged have been described to avoid having to remove the boat from the water. U.S. Pat. No. 4,395,966 to Murphy discloses a boat hull scrubber having a one piece belt of abrasive material to which a plurality of floats couple along the undersurface. The floats pivot in relation to the belt. The floats forcibly urge the belt into contact with the hull of the boat as operators on the deck of the boat pull either end of the belt. There are several disadvantages to this type and similar types of belt and float technology. The floats can make the belt difficult to engage and control in positional relation to the hull, and the flat belt when drawn against the boat hull can be difficult to draw back an forth due to friction between the belt and the boat hull, and the surface of the belt may not provide a surface as effective in removing the accumulation of marine growth (bacterial growth, algae growth, barnacles, and the like) from the boat hull as brushes.

Similarly, U.S. Pat. No. 5,351,640 to Attaway describes a strap having a plurality of support pads located in cleaning loops disposed along the length of the strap which support cleaning pads in positional relation to the boat hull for cleaning. There are several disadvantages to supported cleaning pad technology. The supported cleaning pads can be operated in only one positional relation to the boat hull making placement of the device in relation to the boat hull more difficult. Additionally, cleaning pads may not readily release removed marine growth resulting trapped abrasives which can subsequently abrade the boat hull.

### SUMMARY OF THE INVENTION

Accordingly, a broad object of the invention can be to provide a boat hull cleaning system which provides a flexible line having central portion along which a plurality cleaning elements have spaced engagement with each of the plurality of cleaning elements configured to provide a body through which the flexible line centrally passes and from which a plurality of flexible members extend a sufficient distance to be engaged with the surface of the boat hull for cleaning.

Another broad object of the invention can be to provide a method of cleaning a boat hull by engagement of a plurality of cleaning elements each having a body from which a plurality of flexible members outwardly extend and through which a flexible line centrally passes. The flexible line can be reciprocally drawn toward the port side of the boat and then toward the starboard side of the boat to reciprocally slidly engage the surface of the flexible members with the boat hull.

Naturally, further objects of the invention are disclosed throughout other areas of the specification, drawings, photographs, and claims.

### BRIEF DESCRIPTION OF THE DRAWINGS

FIG. 1 is an illustration of a particular method of using a particular embodiment of the inventive boat hull cleaning device.

FIG. 2 is a plan view of a particular embodiment of the inventive boat hull cleaning device.

FIG. 3 is a side view of the particular embodiment of the inventive boat hull cleaning device shown in FIG. 2.

FIG. 4 is an end view of the particular embodiment of the inventive boat hull cleaning device shown in FIG. 2.

FIG. 5 is a cross sectional view 5-5 of the particular embodiment of the inventive boat hull cleaning device shown in FIG. 3.

FIG. 6 is a cross sectional view 6-6 of the particular embodiment of the inventive boat hull cleaning device shown in FIG. 3.

FIG. 7 is a cross sectional view 7-7 of the particular embodiment of the inventive boat hull cleaning device shown in FIG. 3.

### DETAILED DESCRIPTION OF THE INVENTION

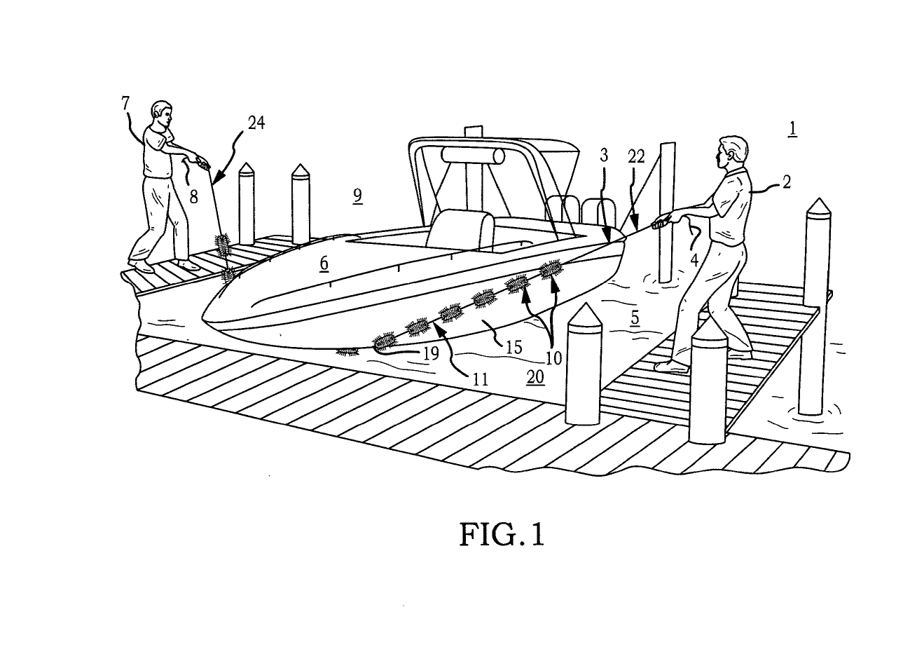

First referring primarily to FIG. 1, a method of using a particular embodiment of the inventive boat hull cleaning system (1) is illustrated. A first person (2) can grip a flexible line (3) proximate a first line end (4) port side (5) of a boat (6). A second person (7) can grip the flexible line (3) proximate a second line end (8) starboard side (9) of the boat (6). The flexible line (3) can provide a plurality of cleaning elements (10) having spaced engagement along a central portion (11) of the flexible line (3) each of the plurality of cleaning elements (10) having a plurality of flexible members (12) which extend outwardly from a body (13), the flexible line (3) passing centrally through the body (13) of each of the plurality of cleaning elements (10).

Certain embodiments of the method can further include the step of disposing a spacer element (14) between one or more pair of the plurality of cleaning elements (10) to fix location of spaced engagement of each of the plurality of cleaning elements (10) along the central portion (11) of the flexible line (3) depending upon the configuration of the boat hull (15) of the boat (6). Additionally, the method can further include the step adjusting length of one or more spacer element(s) (14) to vary distance of spaced engagement of the plurality of cleaning elements (10) disposed along the central portion (11) of the flexible line (3).

Certain embodiments of the method can further include the step of coupling a stiffener element (16) to the flexible line (3) whether along a continuous length or between one or more pair of the plurality of cleaning elements (10) to increase the rigidity or decrease flexibility of the flexible line (3) between one or more of the plurality of cleaning elements (10) disposed along the central portion (11) of the flexible line (3).

Certain embodiments of the method can further include the step of establishing the length of the plurality of flexible members (12) coupled to the body (13) of one or more of the plurality of cleaning elements (10) to provide a flexible member cleaning surface (17) defined by location of the air terminals (18) of the plurality of flexible members (12) which can be generally configured as any one or combination of: a cylinder, sphere, prolate spheroid, cone, double sided cone, rectangular volume, square or the like, depending on the configuration of the boat hull (15) of the boat (6).

The central portion (11) of the flexible line (3) along which the plurality of cleaning elements (10) have spaced engagement can be engaged with a portion of the external surface (19) of a boat hull (15) of a boat (6) (the boat hull (15) can be submerged to a depth in an amount of water (20) as shown in FIG. 1 or can be supported out of water (20)) and reciprocally drawn toward the port side (5) of the boat (6) and to the starboard side (9) of the boat (6) to clean the boat hull (15).

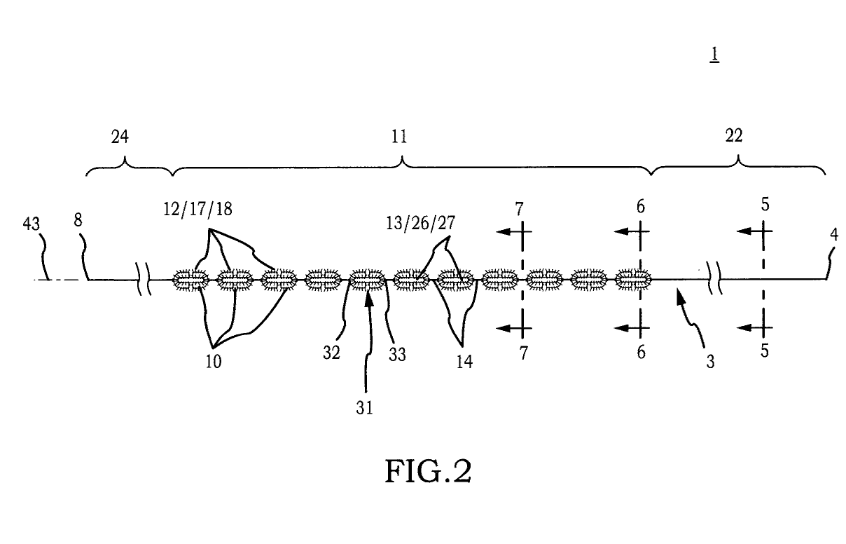

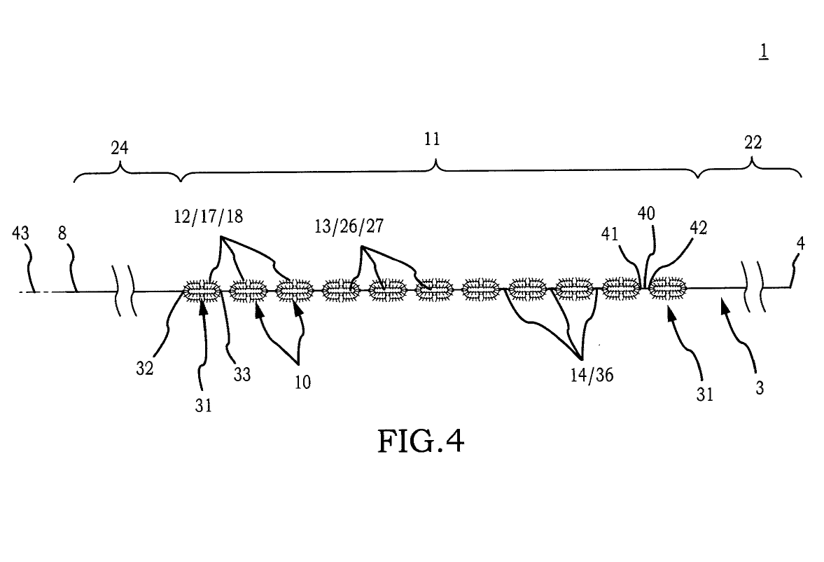

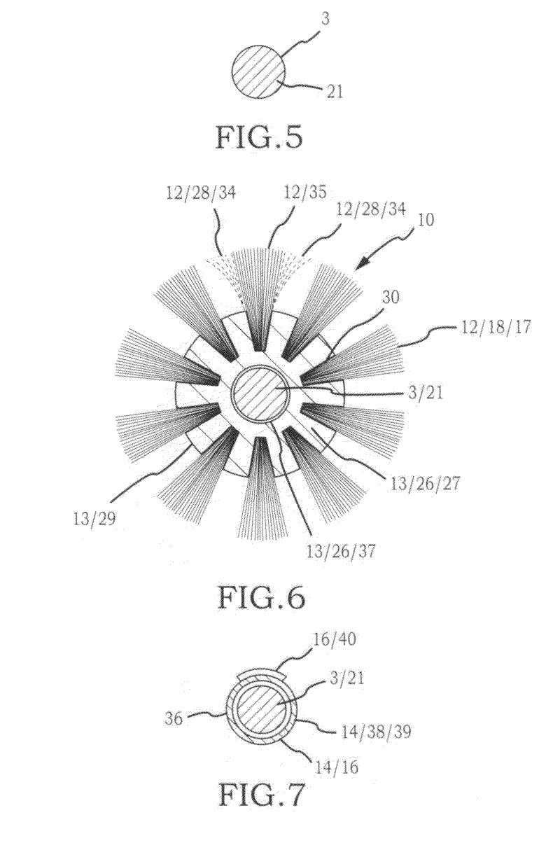

Now referring primarily to FIGS. 2-7, embodiments of the boat hull cleaning system (1) can include a flexible line (3). Typically, the flexible line (3) will have a generally circular cross sectional area (21) consistent with the twisted, laid, plaited, braided, woven, or winded relation of the fibers or the configuration of the solid material which comprise the flexible line (3); however, the invention is not so limited and other cross sectional configurations of the flexible line (3) can be utilized in accordance with the invention such as oval, square, rectangular, multiple separate strands, or the like. The cross sectional area (21) of the flexible line (3) can be selected to provide the strength, flexibility, elasticity and other characteristics to allow the flexible line ( ) to perform the above-described method of cleaning a boat hull (15). Typically, the flexible line (3) having a generally circular cross sectional area (21) will have a diameter in the range of about three eighths inch to about three quarters of an inch. The flexible line (3) can be constructed of natural fibers such as silk, wool, manila hemp, hemp, linen, cotton, coir, jute, sisel, or the like, or more preferably synthetic fibers such as polypropylene, nylon, polyesters, polyethylene, aramids, polyaramids, rayon, or the like, or even metallic fibers such as steel, stainless steel, or the like. The flexible line (3) can have a length sufficient to perform the method above described on a numerous and wide variety of boat hull (15) configurations, typically the length can be in the range of about twenty feet and about thirty feet; although depending on the application the length can be of greater or lesser length. The length of the flexible line (3) can generally be divided to provide a central portion (11) located between a first grippable portion (22) proximate a first line end (4) and a second grippable portion (24) proximate a second line end (8).

Again referring primarily to FIGS. 2-7, embodiments of the boat hull cleaning system (1) can further include a plurality of cleaning elements (10) having spaced engagement along the central portion (11) of the flexible line (3). Each of the plurality of cleaning elements (10) can have a body (13) from which a plurality of flexible members (12) extend outwardly. The body (13), under conditions encompassed by the above described method or substantially similar methods, can provide a generally inflexible body (26) molded, formed, or fabricated from a wide variety of materials such as metal, plastic, wood, or the like, to provide configurations to which the plurality of flexible members (12) can be coupled in outward extending relation. As to other embodiments of the invention, the body (13), under conditions encompassed by the above described method or substantially similar methods, can be configured to provide a generally flexible body (27) molded, formed, or fabricated from a wide variety of materials such as metal, plastic, or the like, to provide configurations to which the plurality of flexible members (12) can be coupled in outward extending relation. The flexible body (27) can provide an amount of flexure (28) owing to the elasticity of the material utilized in producing the flexible body (27) or owing to a plurality of segments coupled in movable relation to one another by pivots, hinges, sockets, or the like.

As one non-limiting example, the inflexible body (26) can have a generally cylindrical external surface (29). While the outside diameter of the cylindrical external surface (29) may vary depending on the particular application, typically the cylindrical external surface (29) can have diameter in the range of about three quarters inch and about three inches. Regardless as to whether the body (13) comprises a generally inflexible body (26) or comprises a flexible body (27), the flexible line (3) passes centrally through the body (13) (generally along the longitudinal axis (43) of the body (13) to dispose the external surface (29) of the body (13) of each of the plurality of cleaning elements (10) in substantial symmetry about the flexible line (3), as opposed to coupling the flexible line (3) proximate the external surface (29) of the body (13) or by a portion of the plurality of flexible members (12).

Again referring primarily to FIGS. 2-7, embodiments of the boat hull cleaning system (1) can further include a plurality of flexible members (12) coupled to the body (13) of each of the plurality of cleaning elements (10). Each of the plurality of flexible members (12) can have a length disposed between the coupled end (30) and the air terminal (18). The length of each of the plurality of flexible members (12) can vary based on a number of factors. First, the length of the plurality of members (12) can vary from embodiment to embodiment to define a numerous and wide variety of configurations of a flexible member cleaning surface (17). The flexible member cleaning surface (17) having configuration defined by location of the air terminals (18) of each of the plurality of flexible members (12) can be configured to provide any one or combination of: a cylinder, sphere, prolate spheroid, cone, double sided cone, rectangular volume, square or the like. As a first non-limiting example, the plurality of flexible members (12) can be substantially the same length and be coupled to generally extend radially outward from a substantially inflexible cylindrical body (26). Accordingly, the flexible member cleaning surface (17) defined by the location of the corresponding plurality of air terminals (18) can be substantially cylindrical in configuration. As a second non-limiting example, utilizing substantially the same inflexible cylindrical body (26) as described in the first example, the plurality of flexible members (12) can be coupled to the substantially cylindrical inflexible body (26) to generally extend radially outward with the plurality of flexible members (12) being longest proximate the medial circumference (31) of one or more of the plurality of cleaning elements (10) and incrementally of lesser length approaching each cleaning element end (32) (33), thereby providing a flexible member cleaning surface (17) generally configured as a prolate spheroid (football shaped). Embodiments of this configuration can have a flexible member cleaning surface (17) having a medial diameter of about three inches to about six inches with the diameter being of incrementally lesser dimension approaching each cleaning element end (32) (33). Understandably, a numerous and wide variety of flexible member cleaning surfaces (17) can be encompassed by the invention and even though the Figures show each of the plurality of cleaning elements (10) having substantially the same configuration of flexible member cleaning surface (17) on an individual device, the various configurations can be used separately or in various permutations and combinations on the same or different devices depending on the application.

Additionally, each of the plurality of flexible members (12) can be sufficiently flexibly resilient such that, under the conditions of the method above described or similar method or use, upon being reciprocally drawn toward the port side (5) of the boat (6) or to the starboard side (9) of the boat (6) to clean the boat hull (15) the engaged portion of the plurality of flexible members (12) achieve a flexed condition (34) by curving, folding or bending over all or a portion of the length of the flexible member (12) and upon being disengaged from the boat hull (15) substantially returns to the prior unflexed condition (35). The amount of flexure in the flexed condition (34) can be controlled by varying the length, thickness and the material of the plurality of flexible members (12). The plurality of flexible members (12) can be made from a wide variety of materials including animal hair such as hog bristle or the like; vegetal fiber such as palmyra or the like; synthetic fiber such as nylon, nylon-type 6, nylon-type 6.6, nylon-type 6.12, polyester, polyethylene, polypropylene, polystyrene, acrylic, or the like; metallic strand such as aluminum, carbon steel, nickel silver, stainless steel, or the like, depending upon the application. While typically, the plurality of flexible members (12) of any one of the plurality of cleaning elements (10) can be of substantially similar material; the invention is not so limited.

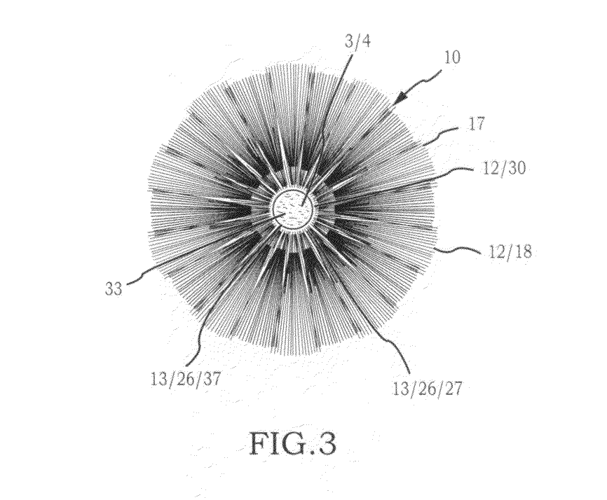

Now referring primarily to FIGS. 2 and 3, the plurality of cleaning elements (10) having spaced engagement along the central portion (11) of the flexible line (3) can be fixedly, slidly, or adjustably slidly coupled to the flexible line (3). As to certain embodiments of the invention, each of the plurality of cleaning elements (10) can have fixed spaced engagement along the central portion (11) of the flexible line (3). The cleaning elements (10) can be spaced in fixed relation to the flexible line (3) by the use of adhesives, compression fit of the body (13) to the corresponding portion of the flexible line (3), molding the body (13) to the corresponding portion of the flexible line (3), enlargement of the flexible line (3) proximate each cleaning element end (32) (33) whether integral to the flexible line (3) or by use of an annular spacer element (36) coupled about the flexible line (3) proximate each cleaning element end (32) (33), or a spacer element (14) coupled about the flexible line (3) between one or more of the pairs of the plurality of cleaner elements (10) or coupled between one or more of the pairs of the plurality of cleaner elements (10). As one non-limiting example, the body (13) of each of the plurality of cleaning elements (10) can provide central longitudinal passage (37) through which the flexible line (3) can pass to allow adjustable spaced engagement of the plurality of cleaning elements (10) along the central portion (11) of the flexible line (3). Adjustable spaced engagement can be achieved by disposing a spacer element (14) between each pair of the plurality of cleaning elements (10) to fix the distance of spaced engagement between the plurality of cleaning elements (10) along said central portion (11) of the flexible line (3). The spacer element (14) can have adjustable length or be adjusted to a particular length to provide fixed adjustable spaced engagement of the plurality of cleaning elements (10) along the central portion (11) of the flexible line (3). As one non-limiting example, the spacer element (14) can be a tubular spacer element (38) defining a tubular circular area (39) in cross section. The tubular spacer element (38) can be configured to provide a selected length disposed between a pair of spacer ends (32) (33). The flexible line (3) can be passed through the tubular spacer element (28) to locate a tubular spacer element (38) between each pair of the plurality of cleaner elements (10) disposed along the central portion (11) of the flexible line (3). Alternately, the spacer element (14) can take the form of an elongate flexible member (40) having each of a pair of member ends (41) (42) coupled to opposed ends (32) (33) of a pair of the plurality of cleaning elements (10).

Again referring primarily to FIGS. 2-7, particular embodiments of the boat hull cleaning system (1) can further include a stiffener element (16) coupled to the flexible line (3) between one or more pair of the plurality of cleaning elements (10). The stiffener element (16) reduces or adjusts the amount of flexure of the flexible line (3) between each pair of the plurality of cleaning elements (10) to achieve a particular range of positional relations of the plurality of cleaning elements (10) with the boat hull (15) or between the pairs of the plurality of cleaning elements (10) in performing the above described method or similar methods. As one non-limiting example, as to those embodiments of the boat hull cleaning system (1) which utilize a tubular spacer element (38) between one or more pairs of the plurality of cleaning elements (10), the stiffener element (16) can be integral to the spacer element (14). The amount of stiffness of the stiffener element (16) adjusted by selection of material of the spacer element (14), the thickness of the wall of the spacer element (14), or the like. Similarly, if the spacer element (14) takes the form of an elongate flexible member (40), the stiffener element (16) can be made integral by selection of material of the elongate flexible member (40); however, the stiffener element (16) need not be integral (one piece) with the spacer element (14) and the stiffener element (16) can be of any of a wide variety of materials to which the flexible line (3) can be made responsive or can be coupled to the flexible line (3) between a pair of the plurality of cleaning elements (10) to reduce flexibility of the flexible line (3).

As can be easily understood from the foregoing, the basic concepts of the present invention may be embodied in a variety of ways. The invention involves numerous and varied embodiments of a boat hull cleaning system including devices and methods for cleaning the hull of a boat.

As such, the particular embodiments or elements of the invention disclosed by the description or shown in the figures or tables accompanying this application are not intended to be limiting, but rather exemplary of the numerous and varied embodiments generically encompassed by the invention or equivalents encompassed with respect to any particular element thereof. In addition, the specific description of a single embodiment or element of the invention may not explicitly describe all embodiments or elements possible; many alternatives are implicitly disclosed by the description and figures.

It should be understood that each element of an apparatus or each step of a method may be described by an apparatus term or method term. Such terms can be substituted where desired to make explicit the implicitly broad coverage to which this invention is entitled. As but one example, it should be understood that all steps of a method may be disclosed as an action, a means for taking that action, or as an element which causes that action. Similarly, each element of an apparatus may be disclosed as the physical element or the action which that physical element facilitates. As but one example, the disclosure of a “flexible line” should be understood to encompass disclosure of the act of “flexing a line”—whether explicitly discussed or not—and, conversely, were there effectively disclosure of the act of “flexing a line”, such a disclosure should be understood to encompass disclosure of a “flexible line” and even a “means for flexing a line.” Such alternative terms for each element or step are to be understood to be explicitly included in the description.

In addition, as to each term used it should be understood that unless its utilization in this application is inconsistent with such interpretation, common dictionary definitions should be understood to included in the description for each term as contained in the Random House Webster's Unabridged Dictionary, second edition, each definition hereby incorporated by reference.

All numeric values herein are assumed to be modified by the term “about”, whether or not explicitly indicated. For the purposes of the present invention, ranges may be expressed as from “about” one particular value to “about” another particular value. When such a range is expressed, another embodiment includes from the one particular value to the other particular value. The recitation of numerical ranges by endpoints includes all the numeric values subsumed within that range. A numerical range of one to five includes for example the numeric values 1, 1.5, 2, 2.75, 3, 3.80, 4, 5, and so forth. It will be further understood that the endpoints of each of the ranges are significant both in relation to the other endpoint, and independently of the other endpoint. When a value is expressed as an approximation by use of the antecedent “about,” it will be understood that the particular value forms another embodiment. The term “about” generally refers to a range of numeric values that one of skill in the art would consider equivalent to the recited numeric value or having the same function or result.

Moreover, for the purposes of the present invention, the term “a” or “an” entity refers to one or more of that entity unless otherwise limited. As such, the terms “a” or “an”, “one or more” and “at least one” can be used interchangeably herein.

Thus, the applicant(s) should be understood to claim at least: i) each of the boat hull cleaning systems herein disclosed and described, ii) the related methods disclosed and described, iii) similar, equivalent, and even implicit variations of each of these devices and methods, iv) those alternative embodiments which accomplish each of the functions shown, disclosed, or described, v) those alternative designs and methods which accomplish each of the functions shown as are implicit to accomplish that which is disclosed and described, vi) each feature, component, and step shown as separate and independent inventions, vii) the applications enhanced by the various systems or components disclosed, viii) the resulting products produced by such systems or components, ix) methods and apparatuses substantially as described hereinbefore and with reference to any of the accompanying examples, x) the various combinations and permutations of each of the previous elements disclosed.

The background section of this patent application provides a statement of the field of endeavor to which the invention pertains. This section may also incorporate or contain paraphrasing of certain United States patents, patent applications, publications, or subject matter of the claimed invention useful in relating information, problems, or concerns about the state of technology to which the invention is drawn toward. It is not intended that any United States patent, patent application, publication, statement or other information cited or incorporated herein be interpreted, construed or deemed to be admitted as prior art with respect to the invention.

The claims set forth in this specification, if any, are hereby incorporated by reference as part of this description of the invention, and the applicant expressly reserves the right to use all of or a portion of such incorporated content of such claims as additional description to support any of or all of the claims or any element or component thereof, and the applicant further expressly reserves the right to move any portion of or all of the incorporated content of such claims or any element or component thereof from the description into the claims or vice-versa as necessary to define the matter for which protection is sought by this application or by any subsequent application or continuation, division, or continuation-in-part application thereof, or to obtain any benefit of, reduction in fees pursuant to, or to comply with the patent laws, rules, or regulations of any country or treaty, and such content incorporated by reference shall survive during the entire pendency of this application including any subsequent continuation, division, or continuation-in-part application thereof or any reissue or extension thereon.

The claims set forth in this specification, if any, are further intended to describe the metes and bounds of a limited number of the preferred embodiments of the invention and are not to be construed as the broadest embodiment of the invention or a complete listing of embodiments of the invention that may be claimed. The applicant does not waive any right to develop further claims based upon the description set forth above as a part of any continuation, division, or continuation-in-part, or similar application.

We claim:

1. An apparatus for cleaning a boat hull of a boat, comprising:
(a) a flexible line having a length disposed between a first line end and a second line end, said length providing a central portion located between a first grippable portion proximate said first line end and a second grippable portion proximate said second line end; and
(b) a plurality of cleaning elements having spaced engagement along said central portion of said flexible line, each of said plurality of cleaning elements having a plurality of flexible members which extend outwardly from a body, said flexible line passing centrally through said body.

2. The apparatus for cleaning a boat hull of a boat as described in claim 1, wherein said body is selected from the group consisting of: an inflexible body and a flexible body.

3. The apparatus for cleaning a boat hull of a boat as described in claim 1, wherein each of said plurality of flexible members have a length which terminates in a corresponding plurality of air terminals, said plurality of air terminals defining the configuration of a flexible member cleaning surface.

4. The apparatus for cleaning a boat hull of a boat as described in claim 3, wherein said flexible member cleaning surface has a configuration selected from the group consisting of a cylinder, sphere, prolate spheroid, cone, double sided cone, rectangular volume, and square.

5. The apparatus for cleaning a boat hull of a boat as described in claim 3, wherein said substantially inflexible body surrounds a longitudinal passage through which said flexible line passes.

6. The apparatus for cleaning a boat hull of a boat as described in claim 5, wherein said central portion of said flexible line slidly engages said longitudinal passage to allow adjustable spaced engagement of said plurality of cleaning elements along said central portion of said flexible line.

7. The apparatus for cleaning a boat hull of a boat as described in claim 6, further comprising a spacer element disposed between each pair of said plurality of cleaning elements to fix location of spaced engagement of said plurality of cleaning elements along said central portion of said flexible line.

8. The apparatus for cleaning a boat hull of a boat as described in claim 7, wherein said spacer element has adjustable length to allow fixed adjustable spaced engagement of said plurality of cleaning elements along said central portion of said flexible line.

9. The apparatus for cleaning a boat hull of a boat as described in claim 6, further comprising stiffener element coupled to said flexible line between each pair of said plurality of cleaning elements.

10. A method of manufacturing an apparatus for cleaning a boat hull of a boat, comprising the steps of:
(a) providing a flexible line having a length disposed between a first line end and a second line end, said length providing a central portion located between a first grippable portion proximate said first line end and a second grippable portion proximate said second line end; and
(b) spacing a plurality of cleaning elements along said central portion of said flexible line, each of said plurality of cleaning elements having a plurality of flexible members which extend outwardly from a body, said flexible line passing centrally through said body.

11. The method of manufacturing an apparatus for cleaning a boat hull of a boat as described in claim 10, further comprising the step of providing said body selected from the group consisting of: an inflexible body and a flexible body.

12. The method of manufacturing an apparatus for cleaning a boat hull of a boat as described in claim 11, further comprising the step of providing said plurality of flexible members with a length which terminates in a corresponding plurality of air terminals, said plurality of air terminals defining the configuration of a flexible member cleaning surface.

13. The method of manufacturing an apparatus for cleaning a boat hull of a boat as described in claim 12, further comprising the step of adjusting said length of said plurality of flexible members to provide a flexible member cleaning surface having a configuration selected from the group consisting of a cylinder, sphere, prolate spheroid, cone, double sided cone, rectangular volume, and square.

14. A method of manufacturing an apparatus for cleaning a boat hull of a boat as described in claim 11, further comprising the step of establishing a longitudinal passage surrounded by said substantially inflexible body through which said flexible line passes.

15. A method of manufacturing an apparatus for cleaning a boat hull of a boat as described in claim 14, further comprising the step of slidely engaging said longitudinal passage with said central portion of said flexible line to allow adjustable spaced engagement of said plurality of cleaning elements along said central portion of said flexible line.

16. A method of manufacturing an apparatus for cleaning a boat hull of a boat as described in claim 15, further comprising the step of disposing a spacer element between each pair of said plurality of cleaning elements to fix location of spaced engagement of said plurality of cleaning elements along said central portion of said flexible line.

17. A method of manufacturing an apparatus for cleaning a boat hull of a boat as described in claim 16, further comprising the step of adjusting length of said spacer element to allow fixed adjustable spaced engagement of said plurality of cleaning elements along said central portion of said flexible line.

18. A method of manufacturing an apparatus for cleaning a boat hull of boat as described in claim 17, further comprising the step of coupling a stiffener element to said flexible line between one or more of each pair of said plurality of cleaning elements.

19. A method of cleaning a boat hull of a boat, comprising the steps of:
a) gripping a flexible line proximate a first line end port side of a boat;
b) gripping said flexible line proximate a second line end starboard side of a boat, said flexible line having a plurality of cleaning elements having spaced engagement along a central portion of said flexible line, each of said plurality of cleaning elements having a plurality of flexible members which extend outwardly from a body, said flexible line passing centrally through said body;
c) engaging said plurality of cleaning elements having spaced engagement along said central portion of said flexible line with said boat hull; and
d) reciprocally drawing said flexible line toward said port side of said boat and said starboard side of said boat.

20. The method of cleaning a boat hull of a boat as described in claim 19, further comprising the step of disposing a spacer element between each pair of said plurality of cleaning elements to fix location of spaced engagement of each of said plurality of cleaning elements along said central portion of said flexible line.

21. The method of cleaning a boat hull of a boat as described in claim 20, further comprising the step of adjusting length of said spacer element to adjust spaced engagement of each of said plurality of cleaning elements along said central portion of said flexible line.

22. The method of cleaning a boat hull of a boat as described in claim 21, further comprising the step of coupling a stiffener element to said flexible line between each said pair of said plurality of cleaning elements.
